(19) United States
(12) Patent Application Publication
(10) Pub. No.: US 2014/0261151 A1
(43) Pub. Date: Sep. 18, 2014

(54) METHOD AND SYSTEM FOR PROVOKING AN AVOIDANCE BEHAVIORAL RESPONSE IN ANIMALS

(71) Applicant: Lite Enterprise, Inc., Nashua, NH (US)

(72) Inventor: Donald Ronning, Nashua, NH (US)

(73) Assignee: Lite Enterprise, Inc., Nashua, NH (US)

(21) Appl. No.: 14/228,536

(22) Filed: Mar. 28, 2014

Related U.S. Application Data
(63) Continuation-in-part of application No. 13/622,448, filed on Sep. 19, 2012.
(60) Provisional application No. 61/626,308, filed on Sep. 23, 2011.
(60) Provisional application No. 61/626,377, filed on Sep. 26, 2011.
(60) Provisional application No. 61/641,152, filed on May 1, 2012.

(51) Int. Cl. A01M 29/10

(52) U.S. Cl. CPC A01M 29/10
USPC 116/22 A

(57) ABSTRACT

The system and method of producing an avoidance response in an animal, and more particularly, producing an avoidance response by illuminating the animal with light or sound of sufficient wavelength, intensity, frequency, and duration to create the desired avoidance response in the animal. The system and method of producing top predator behavior to produce an avoidance repose in an animal by utilizing one or more unmanned vehicles in the air, on land and/or in the water where the unmanned vehicles comprise illumination sources.

### CROSS REFERENCE TO RELATED APPLICATIONS

This application is a continuation-in-part application of U.S. patent application Ser. No. 13/622,448, filed Sep. 19, 2012, which claims the benefit of U.S. Provisional Application No. 61/626,308, filed Sep. 23, 2011; U.S. Provisional Application No. 61/626,377, filed Sep. 26, 2011; and U.S. Provisional Application No. 61/641,152, filed May 1, 2012, the contents of all of which are incorporated by reference herein in their entirety.

### FIELD OF THE INVENTION

The present invention relates to the production of an avoidance response in an animal, and more particularly to the production of an avoidance response through the external stimulation of the visual and auditory receptors of an animal with light or sound of sufficient wavelength, intensity, frequency and duration to create the desired avoidance response in the animal, at times this is in combination with the motion of a moving vehicles.

### BACKGROUND OF THE INVENTION

Managing the interaction between animals and other objects in the environment has important commercial, environmental, and social significance. It is desirable to have a method of causing an animal not to enter, or inducing an animal to leave, an area to avoid the risk of collisions, unwanted interactions between animals and humans or machinery, or interactions with toxic environments. Various methods have been employed to reduce the hazard of incursions by animals into protected ground or water areas and low altitude airspace. These methods may include selective hunting of problem species. However, in many cases the problem species is an internationally protected species and hunting is illegal. Non-lethal methods using frightening noises or sights can sometimes be used effectively in controlling transient migratory species, but the effectiveness of these techniques is usually short-lived. Animal management methods such as habitat modification, intended to deprive animals of food, shelter, space, and water on or around a protected space, have been the most effective longer-term tactic for reducing the population of animals. While techniques that modify the habitat can reduce the risk, these methods are only partially effective and have a limited geographic range. In contrast, embodiments of the present invention have been successful in inducing an involuntary avoidance response in animals by illuminating one or more animals with light of sufficient wavelength, intensity, and duration to create the desired avoidance response in the animal, thereby causing the animal to leave, or not to enter, a protected area.

### SUMMARY OF THE INVENTION

It has been recognized that providing effective suppression of wildlife from a designated area through either directed or non-directed stimulation through the application of illumination of the area with light or sound of sufficient wavelength, intensity, frequency and duration and in some cases, in combination with the motion of vehicles to induce either an involuntary or a voluntary response of avoidance in the animal is needed.

One aspect of the present invention is a method for producing an avoidance response in an animal, comprising; providing a plurality of illumination sources wherein the illumination source is a light emitting diode having a peak emission wavelength from about 360 nm to about 680 nm; providing a plurality of sensors; and providing a central controller, wherein the central controller is configured to receive data from the plurality of sensors, combine the data received from the plurality of sensors to create a situational awareness, and communicate a response to the plurality of illumination sources thereby producing an avoidance response in one or more animals.

One embodiment of the method for producing an avoidance response in an animal is wherein the situational awareness comprises the range, distance, and direction of egress of one or more animals.

One embodiments of the method for producing an avoidance response in an animal further comprises producing a sound within the frequency range of 200-5000 Hz.

One embodiments of the method for producing an avoidance response in an animal further comprises providing one or more unmanned vehicles wherein the plurality of illumination sources are connected to the one or more unmanned vehicles.

One embodiment of the method for producing an avoidance response in an animal is wherein the one or more unmanned vehicles are stationary.

One embodiment of the method for producing an avoidance response in an animal is wherein the one or more unmanned vehicles are operable in the air, in the water, or on land.

One embodiment of the method for producing an avoidance response in an animal is wherein the one or more unmanned vehicles simulate top predator behavior to produce an avoidance response in one or more animals.

One embodiment of the method for producing an avoidance response in an animal is wherein the top predator behavior comprises one of the one or more unmanned vehicles applying a maximum concurrent stimuli during an initial period followed by each of the other one or more unmanned vehicles sequentially applying a maximum stimuli.

One embodiment of the method for producing an avoidance response in an animal is wherein the top predator behavior comprises decreasing the distance or changing the rate of change between the one or more unmanned vehicles and the one or more animals.

One embodiment of the method for producing an avoidance response in an animal is wherein the avoidance response is an involuntary response resulting from a brightness contrast to the apparent background brightness from the perspective of the one or more animals of at least a 10:1 ratio and the illumination intensity is less than about 12 mW/cm².

One embodiment of the method for producing an avoidance response in an animal is wherein the avoidance response is an involuntary response resulting from an induced oscillating eye pupil dilation resulting from a changing illumination state between ‘on’ and ‘off’ conditions with a time interval from about 100 milliseconds to about 5 seconds.

One embodiment of the method for producing an avoidance response in an animal is wherein the spatial separation of the plurality of illumination sources is an angular amount from about 0 degree to about 60 degrees.

One embodiment of the method for producing an avoidance response in an animal is wherein the response communicated by the central controller to the plurality of illumination sources is configured to modify the intensity, direction, sequence, duration of illumination, color, brightness, blinking effect, uncoordinated movement of the light, uncoordinated movement of multiple lights, or a coordinated movement of multiple lights thereby increasing the perceived risk of predation and producing an avoidance response in one or more animals.

One embodiment of the method for producing an avoidance response in an animal is wherein the sensor is a camera.

One embodiment of the method for producing an avoidance response in an animal is wherein the central controller determines the appropriate response to the presence of the one or more animals using rules of escalating responses to issue illumination commands consisting of range, bearing azimuth, power level of emission, duration of emission, and coordinated flashing sequence to each illumination source to be directed at the one or more animals.

Another aspect of the present invention is a system for producing an avoidance response in an animal, comprising; a plurality of illumination sources wherein the illumination source is a light emitting diode; a plurality of sensors; and a central controller configured to receive data from the plurality of sensors, combine the data received from the plurality of sensors to create a situational awareness, and communicate a response to the plurality of illumination sources to produce a brightness of light that is equal to or greater than the brightness perception of the animal species to the natural solar spectral irradiation found within the ecosystem of the species, thereby producing an avoidance response in an animal.

One embodiment of the system for producing an avoidance response in an animal is wherein the plurality of illumination sources is configured to illuminate with light about 1.0 mW/cm² for spectral emissions less than about 400 nm and about 12 mW/cm² for spectral emissions from about 400 nm to about 680 nm.

One embodiment of the system for producing an avoidance response in an animal is wherein the sensor is a camera.

One embodiment of the system for producing an avoidance response in an animal is wherein the brightness of light is equal to or greater than a factor of 10 different from the background brightness perceived by the animal species within the ecosystem.

One embodiment of the system for producing an avoidance response in an animal is wherein the illumination sources are configured to alternate between ‘on’ and ‘off’ conditions with a time interval from about 100 milliseconds to about 1.5 seconds.

One embodiment of the system for producing an avoidance response in an animal is wherein the response communicated by the central controller to the plurality of illumination sources is configured to modify the intensity, direction, sequence, duration of illumination, color, brightness, blinking effect, uncoordinated movement of the light, uncoordinated movement of multiple lights, or a coordinated movement of multiple lights thereby increasing the perceived risk of predation and producing an avoidance response in one or more animals.

One embodiment of the system for producing an avoidance response in an animal further comprises one or more unmanned vehicles, wherein the plurality of illumination sources are connected to the one or more unmanned vehicles.

One embodiment of the system for producing an avoidance response in an animal is wherein the one or more unmanned vehicles are stationary.

One embodiment of the system for producing an avoidance response in an animal is wherein the one or more unmanned vehicles are operable in the air, in the water, or on land.

One embodiment of the system for producing an avoidance response in an animal is wherein the one or more unmanned vehicles simulate top predator behavior to produce an avoidance response in one or more animals.

One embodiment of the system for producing an avoidance response in an animal is wherein the top predator behavior comprises one of the one or more unmanned vehicles applying a maximum concurrent stimuli during an initial period followed by each of the other one or more unmanned vehicles sequentially applying a maximum stimuli.

One embodiment of the system for producing an avoidance response in an animal is wherein the top predator behavior comprises decreasing the distance or changing the rate of change between the one or more unmanned vehicles and the one or more animals.

One embodiment of the system for producing an avoidance response in an animal further comprises one or more sources of sound within the frequency range of 200-5000 Hz.

Another aspect of the present invention is a method of producing top predator behavior to produce an avoidance response in an animal, comprising providing one or more unmanned vehicles; providing a plurality of illumination sources connected to the one or more unmanned vehicles, wherein the illumination source is a light emitting diode; providing a plurality of sensors; providing a central controller, wherein the central controller is configured to receive data from the plurality of sensors, combine the data received from the plurality of sensors to create a situational awareness, and communicate a response to the plurality of illumination sources; and coordinating the movement of the one or more unmanned vehicles to simulate top predator behavior thereby producing an avoidance response in one or more animals.

One embodiment of the method of producing top predator behavior to produce an avoidance response in an animal is wherein the top predator behavior comprises one of the one or more unmanned vehicles applying a maximum concurrent stimuli during an initial period followed by each of the other one or more unmanned vehicles sequentially applying a maximum stimuli.

These aspects of the invention are not meant to be exclusive and other features, aspects, and advantages of the present invention will be readily apparent to those of ordinary skill in the art when read in conjunction with the following description, appended claims, and accompanying drawings.

### BRIEF DESCRIPTION OF THE DRAWINGS

The foregoing and other objects, features, and advantages of the invention will be apparent from the following description of particular embodiments of the invention, as illustrated in the accompanying drawings in which like reference characters refer to the same parts throughout the different views. The drawings are not necessarily to scale, emphasis instead being placed upon illustrating the principles of the invention.

FIG. 1 shows the maximum extraterrestrial solar spectral irradiation striking the earth's surface.

FIG. 2 demonstrates the luminous efficiency function or the eye sensitivity function of a human.

FIG. 3 shows typical absorption characteristics of solar spectral irradiation striking the earth's surface as it penetrates water.

FIG. 4A demonstrates how aquatic species' light sensitivities and evolutionary adaptations to physical light penetration correlate with the light found within the ecosystem's light and can govern visually mediated predator-prey interactions.

FIG. 4B demonstrates how avian species' light sensitivities and evolutionary adaptations to physical light penetration correlate with the light found within the ecosystem's light and can govern the visually mediated predator-prey interactions.

FIG. 5 demonstrates that each animal species has its own unique wavelength-weighted spectral values for brightness perception which may or may not include spectral sensitivity to ultraviolet light.

FIG. 6 demonstrates that unnatural characteristics of the light, sound, or motion source(s) within an ecosystem capable of mimicking a top predator to a species within the ecosystem leading to an enhanced predatory/prey interaction thereby increasing the perceived risk of predation and provoke an avoidance behavioral response.

FIG. 7 shows an embodiment of the system of provoking an avoidance behavioral response in animals of the present invention.

FIG. 8 shows an embodiment of the system of provoking an avoidance behavioral response in animals of the present invention.

FIG. 9 shows an embodiment of the system of provoking an avoidance behavioral response in animals of the present invention.

### DETAILED DESCRIPTION OF THE INVENTION

The present invention relates to the inducement of an avoidance behavioral response, either voluntary or involuntary, in animal species by stimulating the neural pathways of the visual sensory system in a manner that provokes a threatened or uncomfortable response without causing physiological damage to the species.

It is recognized that governments around the world are seeking ways of producing the energy needs and food sources required for a growing human population while minimizing the environmental impact and health risks to all species found within the ecosystem. In an effort to combat climate change by reducing CO₂ emissions, governments around the world have set ambitious targets for renewable energy generation and support efforts to more efficiently produce greater amounts of food in farmed conditions while minimizing the impact on the diversity of species naturally occurring within the surrounding ecosystem. Furthermore, the unintended interaction of wildlife species with machinery, such as aircraft, wind turbines, dams, power turbines, waste heat from power plants, tall buildings and towers, and the like can have significant unintended consequences for both the animal species and humans, which may be avoidable, as described herein.

Certain embodiments of the present invention will find a particular application in the deterrence of birds, bats, fish, and other animal species that may not be aware of a moving aircraft, vehicles, or of the rotors of a wind turbine. Since neither aircraft, vehicles, nor wind turbine rotors are recognized as being predators, birds, for example, are not automatically cautious when in the proximity of such equipment unless previous experience (direct observation) has produced a hazard avoidance reaction. Oftentimes, the animal is unaware of the object or the risk of collision that it presents until it is too late to take an avoidance action.

The Endangered Species Act in 1973, the Bald and Golden Eagle Protection Act of 1940, and The Migratory Bird Treaty Act of 1918 established efforts to prevent or mitigate harm to the nearly 800 species that are in danger of becoming extinct. Many of the species listed are of great interest. Numerous animal species are known to become habituated when repeatedly exposed to these collision threats leading them to be even less cautious than they might otherwise be. The behavioral response of avoidance of animal species from aircraft wind turbines, and other machinery is necessary. Heightening the animal's awareness to the threat can maximize the time of response to escape the threat.

Certain embodiments of the present invention will find a particular application in the deterrence of aquatic animal species that frequent water inlets, such as those near power plants and water supplies, which may become restricted or blocked by their presence. The U.S. Section 316(b) of the Clean Water Act requires National Pollutant Discharge Elimination System (NPDES) permits for facilities using cooling water intake structures. The permits contemplate the location, design, construction, and capacity of the structures and reflect the best technology available to minimize harmful impacts on the environment. Currently, the withdrawal of cooling water by facilities removes billions of aquatic organisms from waters of the United States each year, including fish, fish larvae and eggs, crustaceans, shellfish, sea turtles, marine mammals, and other aquatic life. Most of the impact is to early life stages of fish and shellfish through impingement and entrainment. The Marine Mammal Protection Act of 1972 prohibits the taking and exploitation of any marine mammal species that is in danger of becoming extinct. The behavioral response of avoidance of animal species from critical water inlets, turbines, and other machinery is necessary. Heightening the animal's awareness to the threat can maximize the time of response to escape the threat.

Certain embodiments of the present invention will find a particular application in the deterrence of reduction of predation losses at aquatic farms. As an example, significant losses are suffered at mussel farms by the diving Eider duck species, Somaleria mollissima. The Eider duck dives for crustaceans and mollusks, with mussels being a favored food. The Eider ducks have been known to consume 20% or more of the mussels produced within a protected farm in a season. A great deal of effort and expense is associated with preventing the Eider duck and similar water diving species from entering aquatic farms to minimize predation losses. Another example of predation losses exists with salmon farm pens due to seagulls, cormorants, and other bird species. The behavioral response of avoidance of animal species from feeding upon aquatic farms and other food production facilities is desirable. Heightening the animal's awareness of a threat can induce a deterrence response.

Certain embodiments of the present invention will find a particular application in the deterrence of animal species that are known to enter toxic spaces without recognizing the hazard they present, such as mining and oil fracking holding ponds, oil spills, etc. Other undesirable human and wildlife interactions include; deer grazing on shrubs and gardens, birds feeding upon orchards and at garbage dumps, bears and other animals foraging for food in garbage containers and dumps, and the like. The behavioral response of avoidance of animal species from toxic spaces and other situations where human-animal conflict may arise is desirable. Heightening the animal's awareness of a threat can induce a deterrence response.

It is known that eyes of one kind or another are present in nearly 95 percent of all animal species, indicating that imaging vision provides a great advantage in numerous environments. The spatial acuity (or optical resolving power) of these eyes ranges from spectacularly high in the camera-style eyes of vertebrates and cephalopods, through moderate in the compound eyes of arthropods, to very low in the eyes (or eye-spots) of certain ‘primitive’ invertebrate species. In a survey of photoreceptors and eyes, von Salvini-Plawen & Mayr concluded that eyes had evolved on at least 40 (and possibly up to 65) separate occasions. Vertebrate vision is shaped by the spectral absorbance of opsins, which can be determined through both amino-acid sequence and differential expression.

Opsin photopigments in the photoreceptors of all animal eyes are derived from a common ancestral opsin, even though the commonly known animal opsins fall into two distinct groups: rhabdomeric-opsin and ciliary-opsin which are also commonly called rods and cones. Most vertebrates—species with a bony skeleton and spine—utilize c-opsins, while most invertebrates utilize r-opsins. The evolution of vertebrate retinal opsins has shown that the rod opsin gene (Rh1) has evolved from one of the four pre-existing cone opsins, namely Rh2. See, Okano et al. (1992). Numerous subsequent studies have shown the phylogenetic relationship between opsins in a vast range of organisms; for example, Yokoyama (2000); Arendt & Wittbrodt (2001); Terakita (2005); Suga et al. (2008); Shichida & Matsuyama (2009). As reviewed by Nordstrom et al. (2004) and Larhammar et al. (2009), these branchings are broadly consistent with two rounds of genome duplication (2R) at the base of the vertebrate lineage.

Vertebrate visual pigments are classified into six evolutionarily distinct classes on the basis of the parts of the visual spectrum they are most sensitive to with the following peak spectral absorption; RH1 (rhodopsin; about 500 nm absorbance), RH2 (rhodopsin-like; 470-510 nm), SWS1 (short wavelength; 360-430 nm), SWS2 (SWS1-like; 440-460 nm), LWS/MWS (long or medium wavelength; 510-560 nm) and the P group (pineal-gland specific; 470-480 nm). Gene duplication within these classes can, in concert with mutation of key amino-acid residues in the light-absorbing portions of the proteins, expand their absorbance spectra even further.

Even though the common set of opsin photopigments is shared throughout the animal kingdom, the vision system of various species has evolved and adapted over time to the unique environment in which they live. One example of this is when early chordates moved to greater depths in the sea, where light levels were much lower, the rhabdomeric photoreceptors became less capable of signaling light, because of the lack of the long-wavelength light they needed. It then became advantageous for the ciliary photoreceptors to make synaptic contact onto the rhabdomeric photoreceptors, and use central axonal projections. These modified rhabdomeric photoreceptors then served as retinal output neurons (retinal ganglion cells), with the ciliary photoreceptors signaling solely via the (former) rhabdomeric cells.

Another major evolutionary advance occurred when one class of ciliary photoreceptors became specialized to receive synaptic input from other ciliary photoreceptors, thereby giving rise to the cell class of retinal bipolar cells enabling a great increase in retinal processing power for the retina to compute spatial contrasts which could readily have led to simple spatial visual information being conveyed to the brain. Such animals, whose photoreceptors developed the ability to make use of the enormous thermal stability of the shorter-wave-sensitive c-opsins, and thereby reduce the receptor noise levels to the point where it became possible to detect single photons, would have had a great advantage at night and in deep water. The rod photoreceptors with their requisite properties evolved, combined with the neural wiring of the retina which evolved in such a way that their signals were able to piggyback onto the existing cone system (Lamb et al. 2007). Additional examples of evolutionary adaption of the vision systems include; spectral selection, spectral tuning, concentration and distribution of the opsin photopigments; specialization of rod and cone morphology in relation to the structure of the ganglia, fovea, and lens of a species.

Genomic DNA and molecular sequencing data has shown that much of the higher orders species within the animal kingdom have SWS opsin present and exhibit 4-color cone vision. Color vision is conferred by the cone photopigments, each comprising an opsin transmembrane protein and a 11-cis-retinal chromophore. Diversity in the properties and arrangement of photoreceptors in vertebrates reflects the evolutionary malleability of this system in response to specific visual challenges of individual species.

Opsin proteins can be classified into medium/long wavelength sensitive (M/LWS) and short-wavelength-sensitive (SWS) based on the wavelength of their peak light sensitivity. Comparisons of visual pigments across taxa indicate that spectral tuning and, therefore, the wavelength of peak light sensitivity (λₘₐₓ) are modulated by 5 key critical amino acid sites in M/L WS opsins and at least 11 amino acid sites in SWS opsins.

Classic models of speciation do not easily explain cichlid evolution of the tilapia fish found in the lakes of East Africa which have undergone rapid adaptive species radiations. In the last 10 million years almost 2,000 unique species have evolved from one or a few species, which have culminated in flocks of several hundred closely related but phenotypically diverse species. At least three major selective forces might have contributed to the divergence of cichlid species: selection on ecological traits, sexual selection and genetic conflicts. It is believed these selective forces of evolution are driving the spectral tuning and many other traits found throughout the Animal Kingdom. Within the species diversification of the tilapia, the temporal patterns of opsin gene expression identify a dynamic visual system of tilapia ontogeny resulting in temporal changes is the adult tilapia which has a retina based on three spectral classes of cones (449 nm, 542 nm, and 596 nm) SWS2a, RH2a and LWS genes, respectively.

It has been found that larval and juvenile tilapia express different subsets of the opsins and have more complex visual pigment complements in which four opsin genes are expressed and a brief period around 45-50 days of age when six cone opsins are present. This dynamic progression of expressed cone opsin genes starts with the short wavelength sensitive genes, SWS1 and RH2b, which are then replaced with the longer wavelength sensitive juvenile (SWS2b) and adult (SWS2a, LWS) genes. Ultraviolet/violet sensitivity occurs in many juvenile fishes, as well as fishes that feed on plankton. The expression of the ultraviolet (SWS1) and then violet (SWS2b) sensitive genes in the early life stages of tilapia may, therefore, be important for successful foraging. Another temporal change is that more of the double cones become long wavelength sensitive as the LWS gene becomes the dominant opsin expressed in double cones. The shift toward longer wavelength sensitivity may help tilapia adapt to the typically murky African riverine environment.

Riverine cichlids use vitamin A2 chromophores, a factor which may be correlated with more turbid visual environments and selection for longer wavelength sensitivity. An increase in LWS expression and A2 chromophore use in cichlids was found based upon the study of the murky habitats of Lake Victoria. Africa. Unlike molecular evolutionary computational studies, the clear link between opsin function and the environment has been associated with gross differences in water clarity and water depth (Spady, et. al. 2005).

In one study, it was shown that the ambush predator Dimidiochromis compressiceps expresses LWS, Rh2, and SWS2a genes while the planktivorous Metriaclima zebra expresses Rh2, SWS2b, and SWS1, a radically different subset of opsin genes. Similarly, it has been found that the bird SWS1 site 86 causes a 75 nm spectral shift (Shi, Radlwimmer, and Yokoyama 2001). Most known tuning sites, however, have a much smaller effect of less than 10 nm spatial shift (reviewed in Yokoyama 2002; Takahashi and Ebrey 2003). Is it recognized that light plays a pivotal role in animal orientation and behavior. The African cichlid fish (Cichlidae) Oreochromis mossambicus uses near-infrared (NIR) light as a strong preference for swimming orientation in the direction of NIR light of a spectral range of 850-950 nm at an irradiance similar to values typical of natural surface waters [Shcherbakov, et. al., 2012].

Alosa pseudoharengus, alewife, are an anadromous fish that is an opportunistic feeder that is found in saltwater, fresh water, brackish water and estuaries. They forage either at the surface, by filter-feeding, or by bottom-feeding. Alewife consume zooplankton (small crustaceans), insect larvae, adult insects, fish eggs and larval fish. Young alewives in freshwater feed most actively at night. The schools of fish tend to rise from deeper water to near the surface and disperse as they follow their prey. In the Maritimes, the alewife spends most of its life growing in salt water, and are known to create large runs of adult alewives as they migrate up coastal rivers to spawn in freshwater lakes, ponds, and streams. Alewives only migrate into freshwater during daylight hours by using their sense of smell to return to the streams and lakes where they hatched. Alewives are known to have a complex vision system. Alewives are also known as an invasive species because they cause economic and ecological damages, and are difficult to control. This is of significant concern throughout N. America.

Small birds tend to fly at around 20 kts whereas larger birds, such as geese, may reach speeds of up to 40 kts. Day to day flight altitudes for most birds are in the range 30 feet to 300 feet above ground level (agl) and rarely exceed 1000 feet agl. Migration flights occur at a 5,000-7,000 feet altitude, subject to terrain, but have sometimes been detected at over 20,000 feet. The most likely birds involved in actual impacts with machinery or man-made structures include young birds in proximity to breeding colonies. Day-to-day bird flight activity is dominated by food or foraging. Insects and other invertebrates either on the ground and on foliage or in flight are the predominant source of food, followed by vegetation. Others species depend upon small mammals and amphibians or fish, carrion or rubbish dumps. Most birds fly by day since relatively few species are adapted for night feeding. It is generally estimated that around 90% of all recorded aircraft bird strikes occur during daylight.

Routine daytime feeding-related activity is at its greatest from dawn until late morning. The hazard of flocking may occur in association with favored feeding areas that can be quite transient and effectively unpredictable. Once the usual morning food intake is over, birds tend to indulge in ‘loafing’ or idling in or around large, open, flat and mainly undeveloped areas or shallow water expanses which make ideal drinking and bathing pools. Near dawn and dusk, there may be specifically identifiable transit routes to and from communal roosts for some species. ‘Poor’ weather conditions tend to reduce bird feeding activity and the transit ‘traffic’ associated with it.

A spatial model of environmental conditions that considers the presence of predators and distribution of resources within a geographical region accounts for 60% of pattern of use by a prey species within the geographical region. Behavior can be interpreted as an adaptive response to a perceived risk.

The nature of an animal's behavior is shaped by its ability to assess and behaviorally control the predator-prey interaction which strongly influences decision making in feeding animals, as well as in animals deciding when and how to escape predators, when and how to be social, or even, for fishes, when and how to breathe air [Lima, et. al, 1990]. The extent to which animals can be behaviorally controlled by the perceived risk of predation reflects trade-offs between the risk of predation and the benefits to be gained from engaging in a given activity. When animal reproduction is involved, the risk of predation perceived by animals is greatly changed. The perception of risk is optimized when the animal experiences an unanticipated and/or an abnormal stimuli within a conflict zone in the air or water which leads to a hazard avoidance reaction. To minimize the risk of animal habituation to such stimuli requires that the stimuli be erratic, persistent, and sufficiently strong to encourage the animal to relocate to adjacent zones which offer lower conflict risk.

It is also recognized that microenvironments within a zone may be altered by sustained, long-term treatment. For example, the performance of two predators is likely to improve if a communications channel facilitates their cooperative behavior. As an example, if one predator gets too close to the other predator, a message can cause the other predator to slow down thus allow an unimpeded attack by the first predator.

It is also recognized that hawks, eagles, and other raptor-type species are at the top of the food chain and have few natural enemies, therefore, they are not easily threatened which leads them to be more likely to become habituated to a stimulus or exhibit a delayed response. It is also understood that hawks, eagles, and other raptors enter a ‘staring’ trance when focusing upon a potential ‘kill’. When they enter this state, it is believed that their ability to recognize visual cues outside of the field of view is greatly diminished. The visual methodology by which ‘birds of prey’ can both view objects sideways with maximum acuity and with binocular vision is explained by the optimized utilization of the two foveae found in most ‘raptor’ species. The unique head positions and behavioral characteristics of spiral flight paths, ‘staring’, and ‘stooping’ role is enabled by the binocular vision. It is also known that many species of birds have a ‘color streak’ aligned to the horizon or at an oblique angle to the horizon.

The Eider sea duck is known to forage at aquaculture mussel farms. The Eider normally swim within 50 ft. of the ocean platform before diving to forage on the mussels. A common approach to minimize predation loss of mussels is to carefully suspend nets that the Eider is unable to swim through. Besides presenting a risk of entanglement to the workers, the cost and constant maintenance effort required to the nets makes this approach undesirable. Another known deterrence technique utilizes low power lasers with 532 nm emission directed at the Eider. Laser eye safety concerns, and limited effective range, particularly underwater, makes this approach undesirable. Another known deterrence technique utilizes underwater hydrophones to produce sounds including the sound of a boat propeller, hull noise as it moves through the water in the vicinity of the mussel farm, and the like. The effective range of this technique is limited by the ability of current state of the art hydrophones to reproduce the typical propeller and hull sounds below 2500 Hz, and particularly in the 200-1000 Hz range.

Bats represent about 20% of all classified mammal species. Some 1,240 bat species are divided into two suborders: megabats (largely fruit-eating) and echolocating microbats. The genetic study of the evolutionary history of bats, covering 65 million years, has shown that all bat species have conserved the long-wave opsin gene while the short-wave opsin has undergone dramatic lineage divergence. The ‘low-duty-cycle’ echolocation taxa has retained UV sensitive opsin and this suggests that these species are dependent on short wave vision for orientation and/or hunting, despite being nocturnal.

Avoidance behavior due to visual stimulus, whether voluntary or involuntary, is dependent upon the ability of the vision system to sense the spectral energy of the object that is either emitted or reflected from the object. An involuntary and nearly instantaneous movement in a response to a stimulus; intense light beam, or unanticipated light beam, or a combination of both, is called an involuntary reflex response. Avoidance behavior due to the stimulus of an a top predator of the species resulting from its silhouette and pattern of motion is dependent upon the perceived predator-prey risk by the prey. The swarming motion of multiple top predators of the species, as described herein, can further enhance the perception of risk by the prey. Avoidance behavior due to the combination of multiple and/or changing patterns and endurance of one or more of the stimulus identified herein further enhances the avoidance behavior of the prey.

A voluntary response involves the brain, which sends out the motor impulses that control movement involving a response to a sensory stimuli. Voluntary behavioral responses of avoidance range from stimulus of pain, surprise, or increased tension to milder responses of being panicked, threatened, or stressed to experiencing a general condition of discomfort. An undesirable voluntary response to a non-threatening spectral stimulus of increased behavioral response can lead to a level of attraction or curiosity of the animal. Once an animal becomes aware of a ‘threat,’ it may attempt to escape by moving in the ‘best available escape path’ given the capabilities of the species. A desirable characteristic of the deterrence system of the present invention allows the species to react to the stimulus at a greater range which maximizes the time available to respond in a potential collision situation and leads to the a more predictable, not panicked, avoidance behavioral response.

In certain embodiments of the system of the present invention, a solution has been devised for the purpose of wildlife deterrence within a protected zone through the behavioral responses of involuntary reflex and the application of complementary voluntary reflex responses, by increasing the perceived risk of the prey to an artificial non-lethal apex-like predator, or a top predator of the target species.

Unmanned Aerial Vehicles (UAVs) and underwater remote operated vehicles (ROVs) are a game-changing technology. UAVs resemble a radio controlled aircraft but they have the capability of being autonomous during flight. Current generations of UAVs are categorized as either fixed wing or helicopters-style aircraft. Neither of which can match a bird's aerodynamic control, wing morphing and/or flapping techniques for pitch control in both forward flight and stalled landing approaches. Numerous applications of UAVs are being developed throughout the world including applications for wildlife management in parks which involves animal conservation, tracking animals, and deterring poachers [Odido, Madara, 2013]. Most of these unmanned aerial vehicles (“UAV”s) generate some amount of noise, and the movement of the UAV's silhouette across the sky is often interpreted as a predator attack. Model aircraft have been used successfully for bird control but are labor intensive and cannot be used next to active runways [Harris, Davis, 1998].

Bird control products can be categorized by the manner in which they deter or disperse birds—novelty avoidance, startle reaction, predator mimics, warning signals, and killing are some examples. Many of the least effective products/techniques are based on the presentation of novel stimuli and/or stimuli that startle birds by the suddenness or loudness of their presentation. Birds tend to avoid any novel stimulus, such as the synthetic sounds produced electronically, because birds do not know whether this is a threat or not. This has obvious survival value. However, sometimes the animal may initially investigate, rather than avoid, a novel stimulus.

Another current technique used for controlling fish passes an electrical pulse to electrically shock fish as they pass over the deterrence device. In all of the nonlethal devices, once the stimulus is no longer novel the stimulus has lost its effectiveness on those birds, fish, or other animals. Similarly, “startle” devices (e.g., gas cannons, load noises, and the like) lose their effectiveness once they become an expected part of the animal's environment.

Although there is a biological basis to these products, any deterrent/dispersal effects are short-lived. The biological basis behind animal control products/techniques that mimic known threats, such as scarecrows and hawk kites, tends to be stronger and longer-lived. The period of effectiveness is related directly to the realism of the model and the perception of a threat.

One embodiment of the present invention is a “swarming” security system using UAVs that is able to direct particular sensors and platforms, to particular locations, with a particular orientation to support all the elements of Finding, Fixing, Tracking, Targeting, Engaging, and Assessing (F2T2EA) [Sauter, et. al, 2009]. Robust autonomous control technologies can reliably coordinate these sensors and platforms and utilize algorithms to autonomously adapt to a changing environment as well as adapt to failures or changes in the composition of the sensor assets. One of the advantages of a “flocking” flight over a single flying robot or UAV is the increased awareness, robustness, and redundancy of the flock. The prey flock or swarm, as a meta-unit, can detect the environment more efficiently than its members individually. The potential application for the system of the present invention is large, ranging from ad-hoc mobile networks through distributed, self-organized units monitoring the environment. [Vasárhelyi, et. al., 2014].

A “swarm” is a collection of interacting agents within an environment that facilitates the functionalities of an agent through both observable and unobservable properties. Thus, a particular environment provides a context for the agent and its abilities. Swarm intelligence is more than a collection of simple autonomous agents that depend on local sensing and reactive behaviors to emerge global behaviors. Functional global patterns emerge as a system of the collective behaviors of unsophisticated agents interacting locally with their environment [Payman, 2002].

As described herein, the agent may consist of either a stationary or a mobile unit. In certain embodiments of the present invention, a large number of agents provide greater influence through direct and/or indirect interactions whereby individual behaviors are magnified. These agents create complex emergent behaviors of the swarm beyond their individual capabilities. Swarm intelligence, as a group of agents whose collective interactions magnifies the effects of individual agent behaviors; result in manifestation of swarm level behaviors beyond the capability of a small subgroup of agents. The formation of a swarm in nature simultaneously provides both the individual and the group a number of benefits arising from the synergy of interaction such as the ability to forage more effectively, the enjoyment of safety in numbers, maximizing the distance they are capable of traveling, and the like.

Referring to FIG. 1, the radiant flux density (Watts/area) is the power incident on a surface. The World Meteorological Organization has determined that a portion of the space energetic particles (e.g., Proton flux density energy spectrum) is absorbed or reflected in the atmosphere. The extraterrestrial solar radiation striking the earth's upper atmosphere throughout the spectral range equals 1,367 Watts/meter² of peak solar radiation then the direct sunlight at the earth's surface when the sun is at zenith is about 1050 W/m², but the total amount (direct and indirect from the atmosphere) hitting the ground is around 1120 W/m². The circumsolar radiation, spectral irradiance within −/−2.5 degree (5 degree diameter) field of view centered on the 0.5 degree diameter solar disk, but excluding the radiation from the disk, is 887 W/m² striking the earth's surface. This is based upon ASTM G173-03 Reference Spectra for the spectral ranges of interest; 0.1% percent (UVA: 365-400 nm), 13% percent (Blue: 401 to 500 nm), 13% percent (Green: 501 to 585 nm), and 14% percent (Red: 586 to 680 nm).

Referring to FIG. 2, the conversion between radiometric and photometric units is provided by the Commission Internationale de I'Éclairage (CIE) which introduced the human photopic eye sensitivity function V(λ) for point-like light sources where the viewer angle is 2°. Photopic vision relates to human vision at high ambient light levels when vision is mediated by cones. Scotopic vision relates to human vision at low ambient light levels when vision is mediated by rods. Rods have a much higher sensitivity than the cones. This is the current photometric standard in the United States. The luminous flux measures the wavelength-weighted luminosity function to correlate to human brightness perception of how much the incident light illuminating the surface. Not all wavelengths of light are equally visible, or equally effective at stimulating vision, due to the spectral sensitivity of the eye. Even though approximately 2% of human cones are blue color sensitive, they contribute an equal portion to our perception of white color balance as described by the Stockman & Sharpe (2000) functions. It is understood that humans and animals have greatly different luminous flux functions.

One embodiment of the present invention relates to a system for causing animals to leave, or not to enter, an area by inducing an avoidance response in animals that possess photoreceptors, cryptochrome, or magnetoreceptors. One embodiment of the present invention comprises illuminating the animals with ultra-violet light, which cannot be directly sensed by humans.

Referring to FIG. 3, the absorption coefficient for pure water as a function of wavelength λ is shown. Water absorbs visible light in ˜100 m depth (400-700 nm). The wavelengths of ambient light and thresholds of light intensity vary as a function of water depth and dissolved organic matter. Light is also scattered by water molecules creating polarized light and by silts and clays creating turbid conditions. As a result of these changes in the visual environment, the visual systems of fishes have developed many adaptations, and are finely tuned to the spectrum and intensity of light in the relevant microhabitat. Aquatic animals face the problem that penetration of light in water is restricted through high attenuation which limits the use of visual cues. Variations in the physical light penetration in different ecosystems have been shown that correlate with the aquatic species sensitivities commonly found within the ecosystems.

Referring to FIG. 4A, absorption spectra of all visual expression in the zebrafish which has two red (LWS-1 and LWS-2), four green (RH2-1, RH2-2, RH2-3 and RH2-4) and single blue (SWS2) and ultraviolet (SWS1) opsin genes in the genome is shown. SWS2, LWS-1 and LWS-2 are located in one tandem gene cluster and RH2-1, RH2-2, RH2-3 and RH2-4 form another tandem gene cluster. The peak absorption spectra (λₘₐₓ) of these visual pigments differed markedly from each other by reconstituting functional photopigments in vitro. Aquatic species' light sensitivities undergo evolutionary adaptations to physical light penetration and correlate with the light found within the ecosystem. Visually mediated predator-prey interactions are highly dependent on the environmental light regime. Similar adaptions and finely tuned visual systems are known with birds and other mammals found in atmospheric microenvironments which can influence their predator-prey interactions.

Referring to FIG. 4B, studies of the avian retina indicate that birds can distinguish light with a wavelength ranging from approximately 325 nm (ultraviolet) through the range of wavelengths visible to humans (about 400 nm to about 700 nm). While human color vision is based on three color channels, birds are generally considered to be tetrachromatic, and some species may even be pentachromatic. A tetrachromatic vision system can distinguish four primary colors: ultraviolet (UV), blue, green, and red corresponding to the peaks in the spectral absorption probability.

The relationship of the behavior of animals to the perception of a light source as it is being illuminated can vary significantly. When the animal is initially illuminated with a directed beam of light, the response can range from a mild voluntary reaction to a strong involuntary reaction, which is dependent upon the power level and perceived pattern of motion observed by the animal.

One aspect of the present invention is a method of managing the interactions between animals and a wide variety of objects ranging from stationary objects, to objects that enter, transit, or leave an area. Pulsing lights that are attached to machinery can provide a method of controlling the interaction of an animal and an object; these systems have characteristics that limit their effectiveness and desirability in many applications. Flashing light systems typically rely on the fixation of the animal with one or more point sources of light emissions, and thus the effectiveness of the system is likely to be strongly influenced by the angle of approach of the animal to the object to which the light source is attached. For example, it may be difficult or impractical to provide light sources that are visible to animals that are free to approach an object from varying directions. A more effective method results when an escalation sequence of illumination to the animal progresses from general involuntary eye dilation to create awareness, to a sequence of illumination to the animal that creates a perception of motion, to a strong illumination that invokes an increased acuteness inducing an involuntary escape reaction. The escalation sequence corresponds to transitioning from voluntary to involuntary responses. In one embodiment of the present invention, the transition is to a flash frequency from a constant illumination for two or more separated light sources that appear to have a high rate of speed of results in removing an animal from a protected area. In certain embodiments, the illumination is form a fixed or stationary source. In certain embodiments, the illumination is from a mobile or moving source.

The maximum permissible exposure (MPE) for humans is the highest power or energy density (in W/cm² or J/cm²) of a light source that is considered safe, i.e. that has a negligible probability for creating damage. The safe standard for humans is usually defined as about 10% of the dose that has a 50% chance of creating damage under worst case scenarios. The MPE in power density is identified for varying exposure time for various wavelengths according to international standard IEC 60825 for lasers to avoid potential human injuries such as burn to the retina of the eye, or even the skin. In addition to the wavelength and exposure time, the MPE takes into account the spatial distribution of the light (from a laser or otherwise). The worst-case scenario is assumed, in which the eye lens focuses the light into the smallest possible spot size on the retina for the particular wavelength and the pupil is fully open. Although the MPE is specified as power or energy per unit surface, it is based on the power or energy that can pass through a fully open human pupil (0.39 cm²) for visible and near-infrared wavelengths.

Referring to FIG. 5, illuminance is the total luminous flux incident on a surface, per unit area that is wavelength-weighted by the luminosity function to correlate with human brightness perception. The ratio of light energy striking a surface area varies upon time of the day, latitude on the earth, and general sky conditions. The corresponding Watts/cm² of UVA light (360-400 nm) for differing light conditions is derived by calculating the proportional ratio to full, noontime sunlight at the equator using ASTM 0173-03 reference spectra. This would represent the intensity of UVA incident upon the ocular system under various lighting conditions. Each animal species has its own unique wavelength-weighted spectral values which may include spectral sensitivity to UVA light.

Humans do not have a spectral sensitivity to UVA light. The use of high intensity light sources to influence the behavioral response must be recognized by an animal as unnatural or unfamiliar which changes the perceived predator-prey threat and leads to a deterrence interaction or a behavioral response. The wavelength and the intensity of the light striking the visual system of the animal must be selected to correspond to the visual system of the animal within the relevant microenvironments in order to influence the predator-prey interactions.

Referring to FIG. 6, a schematic of both voluntary and involuntary reflex avoidance responses to a high brightness light sources induced in animal species is shown. The spectral range of the light to be utilized must take into account the animal species' sensitivities commonly found within the ecosystems. The use of UVA in the spectral range of 360-400 nm is preferred in situations where a high brightness light may be objectionable when observed by humans. The nonlethal predator-prey interaction leading to the behavioral response of deterrence is preferred, where the animal is not harmed. In certain embodiments of the present invention, the strategy is to defend areas where ecological niche overlap occurs through “terrain fear factor” which is an idea that assesses the risks associated with predator/prey encounters causing a species to forage in a terrain with a lower predation risk as opposed to one with high predation risk. The desired inducement of behavioral deterrence responses may be caused by a single stimulus or a complex combination of stimulus. A bright light of sufficient power level is needed to strike the animal's eye to induce the involuntary reflex avoidance response which may be characterized by pain, surprise, or a high level of anxiety. A less bright light of sufficient power level is needed to strike the animal's eye to induce the voluntary reflex avoidance response which may be characterized by panic, stress, or a feeling of being threatened. An even less bright light level is needed to strike the animal's eye to induce the awareness level response which is characterized by a level of discomfort, curiosity, or habituation.

The power (in W/cm²) of a light impinging upon various animals that is required to initiate an involuntary response and detection of motion varies. The light source that directly illuminates the animals should be greater than the power levels identified to cause eye dilation in dark conditions. This value increases when ambient illumination also increases. In one embodiment, directed illumination consisting of a beam of 380 nm+/−20 nm light with an intensity of 10-5 W/cm² in bright midday light conditions has been observed to induce Red-tailed Hawk (Buteo jamaicensis), a diurnal raptor, to egress the area soon after being illuminated. Similar results were observed with Starling (Sturnus Vulgaris), a passerine. The same directed illumination intensity of Little Brown Bat (Myotis lucifungus) approximately 30 minutes after sunset induces an immediate change in the flight path and usually results in the bats egressing the airspace after 15-30 minutes of being repeatedly illuminated. Mallard ducks (Anas Platyrhynchos) that are frequently fed old bread by humans responds to an intensity of 10⁻⁶ W/cm² in bright midday light conditions by either swimming or flying towards the light source but would move away when intensities exceeded 10⁻³ W/cm². Light conditions, time of day, and instinctual behavior of the animal may determine the response to the sensory cues delivered by directed illumination. Similar behavioral responses have been observed with a wide range of avian, mammal, aquatic species, and the like.

The unnatural characteristics of the light source(s) created by the system of the present invention within an ecosystem can simulate a top predator to the species within its ecosystem. These unnatural characteristics may include; color, brightness, blinking effect, uncoordinated movement of the light, uncoordinated movement of multiple lights, or a coordinated movement of the multiple lights. These methods enhance the predator/prey interaction thereby increasing the perceived risk of predation and the benefits to be gained from engaging in an avoidance behavioral response.

In certain embodiments of the present invention, the coordinated movements can resemble swarming. It is important note that convergence on a target is not necessarily “swarming.” Swarming involves the use of decentralized units, in a manner that emphasizes mobility, communication, unit autonomy and coordination or synchronization. The effect of swarming may involve several different behavior characteristics where autonomous or partially autonomous units (e.g., UAVs) take a threatening action from different directions and then regroup. When the units shift the point of attack it is known as pulsing which can lead to a desired response. Manned or unmanned air or underwater vehicle(s) may be fitted with high brightness light sources and may be operated in an independent or coordinated manner to effect a desired behavioral response. For example, repetitive eye dilation induced by a light source can cause a heightened awareness and is capable of inducing a voluntary reflex behavioral response.

Referring to FIG. 7, a RC (radio controlled) aircraft or submersible platform is a cost effective way of implementing an unmanned vehicle with wildlife deterrence capabilities. The use of a styrofoam or polycarbonate type material for the air vehicle offers several advantages including low cost, low weight, and durability, while minimizing the risk of damage in the event of accidental collisions. One embodiment of the present invention utilizes a delta wing aircraft design as shown in FIG. 7. This system offers the advantage of enhanced range, endurance, speed and altitude capabilities versus hover type aircraft. The payload components comprise a battery, motors, propellers, actuators, sensors, cameras, and high brightness LED light sources, a wireless communication module, and a central controller with GPS and microprocessor systems.

Still referring to FIG. 7, the microprocessor and cameras can be found in payload bay 701 or mounted along the airfoil of the vehicle 702. In the dual delta wing design the two sets of propellers 703 are configured to achieve counter-rotation and are capable of containing multiple LED (light emitting diodes) high brightness sources 704, which are located in the forward area of the payload bay. The open-source underwater robot telerobot design from OpenROV 750 has been tested to a depth of 25 m and is being modified to perform at 100 m depth. The central controller and microprocessor system communicates with ROV propulsion, camera, and light control modules which are located in the payload bay 751 through a tether 752. The payload components comprise motors, propellers, actuators, sensors, cameras 753, and high brightness LED light sources and/or sound producing devices 754. In certain embodiments, the submersible ROV is capable of containing multiple LED (light emitting diodes) high brightness sources which are located in the forward area of the payload bay. Modifications of the motor and controller unit can enable untethered, extended operations of the OpenROV.

In certain embodiments, RC craft are controlled by an operator through a wireless link to the craft which is limited to line of sight communication. Alternatively, the flight behavior can be pre-programmed to mimic the behavior motions of the top predator to the species of the environment in which it is being operated. The pre-programming of a flight control module, such as the 3DR PIXHAWK UAV autopilot from 3DRobotics with GPS sensor, enables the pre-programming of excluded flight longitude, latitude, and altitude zones, the flight paths, and flight characteristics of the vehicle. These components must be optimized for minimum weight, size, power consumption, electronic noise generation, waste heat generation, and the like without sacrificing their performance. Several suppliers of suitable components are readily available from RC component suppliers, LED manufacturers, or electronic component suppliers. The camera(s) are capable of detecting objects within their field of view. The video signals can be image processed on-board the vehicle within the microprocessor of vehicle flight controller to detect the movement of animals within field the field of view. Further image processing could enable object recognition or identification of the animals. In certain embodiments, a signal is sent to the vehicle flight controller to modify the operation of the flight controls and light sources. The characteristics of the flight controls can be modified from a power conserving mode into a maximum threatening mode. The central flight controller may send a signal to other vehicles within the area through the wireless communication network which is configured as an ad hoc network. Each vehicle may operate autonomously or in a coordinated manner. In certain embodiments, the only information that each vehicle needs is its own local sensor data.

Referring to FIG. 8, collectively, the controllers, sensors, communications components constitute the payload 800 of the vehicle. The performance of the wildlife deterrence functions of the vehicle require communication and coordination between the components. The components, some with open-source software, can be integrated with custom software modules, to achieve the desired functionality. The hardware components with open source software; camera 801, GPS 806, Autopilot Functions 807, Flight Controller 808, and Radio Telemetry 809, are readily available from RC component suppliers, or electronic manufacturers, or distributors. In certain embodiments, the flight controller 808 is capable of receiving signal commands 817 to actuate the motors and actuators necessary for vehicle movement. In certain embodiments, the autopilot functions 807, GPS, and microprocessor systems and cameras may be found in payload bay 701 or mounted along the airfoil of the vehicle 702. In certain embodiments, the Video Software Package 810 consists of several functional modules; Image Processing 802, Object Recognition 803, Object Tracking 804, and the like, which can be either open-sourced or original source code. The Video Software Package 810 may be integrated with the open source software provided with the Autopilot Functions 807 and swarm control software or communicate directly 815 with the Autopilot Functions 807 from a separate microprocessor platform. In certain embodiments, the Video Software Package 810 receives a video signal or a sequence of still images 811 from the camera 801. The Video Software Package 810 processes the video signal or a sequence of still images. Theoretically, detectors in other frequency ranges (sonar, radar, and infrared) could be used. In certain embodiments, the sensors generate data that can be organized as either 1D, 2D or 3D images that are analyzed to determine the differential motion of an object by comparing temporal differences from sequential images within the field of view. It is understood that predation risk within an ecosystem is species specific. It is further understood that each deterrence unit will require optimal intensities, wavelengths, frequencies, and durations to be most effective. The distance that is perceived as a threat is dependent upon the distance and the rate of change of the distance to the object before a species reacts and is also species specific. Increasing the distance between the object and the species allows for an increased reaction time before a potential collision.

Referring to FIG. 9, an embodiment of the system of provoking an avoidance behavioral response in animals of the present invention is shown. Wildlife deterrence algorithms integrate the inputs from many sources, including but not limited to a Video Software Package, a GPS, one or more light sources, and communications with other wireless Radio Telemetry and communications with other members of the swarm. In certain embodiments, the control commands from the wildlife deterrence algorithms go to the Autopilot Functions which in turn direct a Flight Controller (808) to adjust the flight surfaces of the UAV and power settings to maneuver the unmanned vehicle.

Numerous swarm algorithm development and simulation platforms are available such as SWEEP (Swarm Experimentation and Evaluation Platform), and ECS (Evolutionary Computing for Swarms). ECS represents solutions as finite state machines, which utilize SWEEP to simulate a swarm executing each state machine solution, and employ radix-based ranking to address the multi-objective nature of the problem. In certain embodiments of the present invention, as the size of the swarm and the complexity of the tasks increases, the complexity of the programming and required computing power, supporting electronics, sensors, motors, and the like also increase. A set of algorithms that is minimalistic in cost and hardware performance that is capable of performing in a robust manner has been developed and is being tested.

Still referring to FIG. 9, a microenvironment is illustrated by the bounding conditions of the illustration. The units (UAVs, underwater vehicles, land based vehicles, and the like) are illustrated as UAVs. The area of space to be excluded by operation of the units is encircled in black. The communication of the units communicating with each other within the swarm is illustrated by curved lines. It is to be understood that other embodiments of the invention could operate on land, in the air, in the water, and the like.

It is advantageous that the UAVs forming a swarm utilized for wildlife deterrence are as minimal as possible as far as the power requirements, size, weight, cost, and the like, while maximizing the endurance, flight capabilities, and deterrence capabilities of the units alone or in combination. The development of swarming algorithms can be built to leverage the capabilities of multiple UAVs. Randomized searching is the most basic search strategy capable of being implemented on a UAV swarm which is limited to probabilistic results. Symmetric sub-region searching is preferred when there is little prior information about the target (e.g., size or location), in which each UAV is assigned a search area proportional to its sensor capabilities.

In certain embodiments of the present invention, all vehicles within the swarm are assigned prior coordinates, including longitude, latitude, and elevation of boundary spaces that define one or more excluded zones of operation. The remaining space not excluded is the space in which the units will apply deterrence stimulus. The wildlife deterrence algorithms determine the action to be implemented by the Autopilot Functions of the unit. In certain embodiments, the vehicles that participate in forming a swarm, share a wireless radio network, which is configured to perform as a mesh network utilizing encrypted protocols within the legal ISM radio spectrum. Multiple swarms of units may operate concurrently within a microenvironment through independent mesh networks. In certain embodiments, when a wildlife species is detected by the Video Software Package, the wildlife deterrence algorithms determine and broadcast through the wireless radio network the current OPS location of the vehicle and the direction; azimuth, elevation, range, and predicted heading of the wildlife species to be targeted by the vehicle. The wildlife deterrence algorithms also send a message to all other units within the swarm group informing them of the location of the unit and of the “prey.” Each of the receiving units then responds to the call by ceasing the pre-determined search mode to initiate a “swarm” behavior which involves all units initiating an aggressive mode by applying maximum deterrent stimuli. In certain embodiments, a swarm mode timer begins a 2 minute count down after which only a single unit is allowed to proceed with the maximum deterrent stimuli until the target animal, or animals, leaves the defined protected zone or the location of the animal is lost to the attacking unit. Once a signal that the animal is no longer detected by the initial unit is relayed, a signal is sent via the wireless network to the swarm which enables another unit to take over the role of applying the maximum deterrent stimuli. In certain embodiments, the other units of the swarm standby in close proximity to receive their signal authorizing their initiation of their maximum deterrent stimuli. In certain embodiments of the present invention, only one unit is authorized at a time. In certain embodiments, if none of the units detect the animal after a period of 3 minutes, each unit returns to its original “search” or “forage” mode. If the animal then returns, the “swarm” sequence will initiate again.

In one embodiment of the present invention, the response escalates to match the severity of the threat assessment. The lowest level of illumination protocol response is to illuminate the animal with a low power level designed to cause pupil dilation and elicit a voluntary alert and awareness response. The next level of illumination protocol response is to illuminate the animal with a coordinated flashing from multiple illumination sources to cause the perception of motion. The next higher level of illumination protocol response is to illuminate the animal with a coordinated high-intensity flashing from multiple illumination sources to cause the involuntary startled or dazzled response. The highest level of illumination protocol response is to illuminate with a coordinated constant high-intensity illumination from multiple illumination sources to cause the involuntary acute escape response. At no time is the animal illuminated with a power level that may cause eye damage.

In certain embodiments of the present invention, multiple illumination sources and sensors may communicate with a central controller using either a wire or wireless network. In certain embodiments, sensors may identify the azimuth and range of low flying animals that are within the area. Similarly, the sensors may identify the range, direction, and the like of aquatic animals. The central controller may determine the proximity of the animals and communicate the individual or coordinated illumination response to each of the illumination sources individually on one or more units. The illumination command to each illumination source includes unique commands concerning direction, power level of emission, duration of emission, and coordinated flashing sequence to be followed. The central controller may utilize an escalating sequence of illumination protocols directed at the approaching animals to induce responses ranging from a voluntary alert and avoidance to an acute involuntary escape response. The central control unit may aggregate the data from all available sensors to create a threat assessment to the area of interest.

One embodiment of the central controller is similar to a personal computer system or an embedded processor. The central controller may be controlled by other devices, such as a programmable timer, which may be integral to an on-board computer or may be a stand-alone system capable of communicating with other computers and instruments. The central controller receives data from a plurality of sensors, processes the data according to instructions, sends instructions to a plurality of light sources, and stores the result in the form of signals to control the light source via data packets using TCP protocol. In one embodiment of the present invention, the central controller operates one or more of the light sources in accordance with a plurality of routines in an application program stored on a storage unit. In one embodiment for the present invention, a light illumination routine comprises an instruction, executable by the central controller system that identifies at least one light source in which the power, direction, and duration of illumination is commanded. In one embodiment, the light controller operates the functions of the power supply to the light and commands a motor to index to the appropriate direction to cause directed illumination of one or more animals. In one embodiment, the central controller continues to monitor and respond to the one or more animals until the sensors indicate that the area is without threats.

In certain embodiments, the central controller communicates with the sensors and illumination sources using data packets and TCP protocols over a wireless network. In certain embodiments, the central controller determines the appropriate response to the moving objects of interest using rules of escalating responses to issue illumination commands consisting of range, bearing azimuth, power level of emission, duration of emission, and coordinated flashing sequence to each illumination source to be directed at the one or more animals of interest.

In one embodiment of the present invention, the avoidance response is an involuntary response resulting from a brightness contrast to the apparent background brightness from the perspective of the animal is about a 10:1 ratio. In one embodiment, the ratio is about 20:1, about 30:1, about 40:1, about 50:1, about 60:1, about 70:1, about 80:1, about 90:1, about or 100:1. In one embodiment, the ratio is about 110:1, about 120:1, about 130:1, about 140:1, about 150:1, about 160:1, about 170:1, about 180:1, about 190:1, about or 200:1. In one embodiment, the ratio is about 210:1, about 220:1, about 230:1, about 240:1, about 250:1, about 260:1, about 270:1, about 280:1, about 290:1, about or 300:1. In one embodiment, the ratio is about 310:1, about 320:1, about 330:1, about 340:1, about 350:1, about 360:1, about 370:1, about 380:1, about 390:1, about or 400:1. In one embodiment, the ratio is about 410:1, about 420:1, about 430:1, about 440:1, about 450:1, about 460:1, about 470:1, about 480:1, about 490:1, about or 500:1. In one embodiment, the ratio is about 510:1, about 520:1, about 530:1, about 540:1, about 550:1, about 560:1, about 570:1, about 580:1, about 590:1, about or 600:1. In one embodiment, the ratio is about 610:1, about 620:1, about 630:1, about 640:1, about 650:1, about 660:1, about 670:1, about 680:1, about 690:1, about or 700:1. In one embodiment, the ratio is about 710:1, about 720:1, about 730:1, about 740:1, about 750:1, about 760:1, about 770:1, about 780:1, about 790:1, about or 800:1. In one embodiment, the ratio is about 810:1, about 820:1, about 830:1, about 840:1, about 850:1, about 860:1, about 870:1, about 880:1, about 890:1, about or 900:1. In one embodiment, the ratio is about 1000:1, about 2000:1, about 3000:1, about 4000:1, about 5000:1, about 6000:1, about 7000:1, about 8000:1, about 9000:1, about 10000:1 about 1100000:1, about 10000000:1, or 10000000:1.

In one embodiment of the present invention, the avoidance response is an involuntary response resulting from an illumination intensity of less than about 12.0 mW/cm² for wavelengths (Blue: 401 to 500 nm), (Green: 501 to 585 nm), (Red: 586 to 680 nm), and 1.0 mW/cm² for wavelengths (UVA: 365-400 nm).

In certain embodiments, the avoidance response is an involuntary response resulting from an induced oscillating eye pupil dilation resulting from a changing illumination state between ‘on’ and ‘off’ conditions with a time interval from about 100 milliseconds to about 5 seconds. In one embodiment, the time interval is about 0.005 s about 0.01 s, about 0.05 s, about 0.1 s, about 0.2 s, about 0.3 s, about 0.4 s, about 0.5 s, about 0.6 s, about 0.7 s, about 0.8 s, about 0.9 s, or about 1 s. In one embodiment, the time interval is about 2 s, about 3 s, about 4 s, about 5 s, about 6 s, about 7 s, about 9 s, about 9 s, or about 10 s.

In certain embodiments, the spatial separation of the plurality of illumination sources is an angular amount from about 1 degree to about 15 degrees. In one embodiment, the spatial separation of the plurality of illumination sources is an angular amount of about 0 degree, about 1 degree, about 2 degrees, about 3 degrees, about 4 degrees, about 5 degrees, about 6 degrees, about 7 degrees, about 8 degrees, about 9 degrees, or about 10 degrees. In one embodiment, the spatial separation of the plurality of illumination sources is an angular amount of about 11 degrees, about 12 degrees, about 13 degrees, about 14 degrees, about 15 degrees, about 16 degrees, about 17 degrees, about 18 degrees, about 19 degrees, or about 20 degrees. In one embodiment, the spatial separation of the plurality of illumination sources is an angular amount of about 21 degrees, about 22 degrees, about 23 degrees, about 24 degrees, about 25 degrees, about 26 degrees, about 27 degrees, about 28 degrees, about 29 degrees, or about 30 degrees. In one embodiment, the spatial separation of the plurality of illumination sources is an angular amount of about 31 degrees, about 32 degrees, about 33 degrees, about 34 degrees, about 35 degrees, about 36 degrees, about 37 degrees, about 38 degrees, about 39 degrees, or about 40 degrees. In one embodiment, the spatial separation of the plurality of illumination sources is an angular amount of about 41 degrees, about 42 degrees, about 43 degrees, about 44 degrees, or about 45 degrees. The unaltered emission pattern produced by LEDs is commonly +/−60 degrees, FWHM (full width half maximum). In certain embodiments, the unaltered LED emission pattern will be used.

In certain embodiments, the sound produced to invoke an avoidance response in an animal will be within the frequency range of about 200 Hz to about 5000 Hz. In certain embodiments, the sound produced to invoke an avoidance response in an animal will be within the frequency range of about 200 Hz to about 2500 Hz. In certain embodiments, the sound produced to invoke an avoidance response in an animal will be within the frequency range of about 200 Hz to about 1000 Hz. In certain embodiments, the sound will have a frequency of about 200 Hz, about 300 Hz, about 400 Hz, about 500 Hz, about 600 Hz, about 700 Hz, about 800 Hz, or about 900 Hz. In certain embodiments, the sound will have a frequency of about 1000 Hz, about 1100 Hz, about 1200 Hz, about 1300 Hz, about 1400 Hz, about 1500 Hz, about 1600 Hz, about 1700 Hz, about 1800 Hz, or about 1900 Hz. In certain embodiments, the sound will have a frequency of about 2000 Hz, about 2100 Hz, about 2200 Hz, about 2300 Hz, about 2400 Hz, about 2500 Hz, about 2600 Hz, about 2700 Hz, about 2800 Hz, or about 2900 Hz. In certain embodiments, the sound will have a frequency of about 3000 Hz, about 3100 Hz, about 3200 Hz, about 3300 Hz, about 3400 Hz, about 3500 Hz, about 3600 Hz, about 3700 Hz, about 3800 Hz, or about 3900 Hz. In certain embodiments, the sound will have a frequency of about 4000 Hz, about 4100 Hz, about 4200 Hz, about 4300 Hz, about 4400 Hz, about 4500 Hz, about 4600 Hz, about 4700 Hz, about 4800 Hz, about 4900 Hz, or about 5000 Hz.

In certain embodiments, the response communicated by the central controller to the plurality of illumination sources is configured to modify the intensity, direction, sequence, duration of illumination, and any combination thereof.

In certain embodiments of the present invention band-pass filters are used to narrow the range of wavelengths emitted by the illumination source. In certain embodiments of the present invention, UV pass filters may be used to control the range of wavelengths emitted by the illumination source.

In certain embodiments, the plurality of illumination sources are light emitting diodes having a peak emission wavelength from about 280 nm to about 400 nm. In one embodiment, the light emitting diodes have a peak emission wavelength from about 320 nm to about 400 nm. In one embodiment, the light emitting diodes have a peak emission wavelength from about 340 nm to about 400 nm. In one embodiment, the light emitting diodes have a peak emission wavelength from about 350 nm to about 400 nm. In one embodiment, the light emitting diodes have a peak emission wavelength of about 360 nm, about 370 nm, about 380 nm, about 390 nm, or about 400 nm. In one embodiment, the light emitting diodes have a peak emission wavelength of about 410 nm, about 420 nm, about 430 nm, about 440 nm, about 450 nm, about 460 nm, about 470 nm, about 480 nm, about 490 nm, about 500 nm, about 510 nm, about 520 nm, about 530 nm, about 540 nm, about 550 nm, about 560 nm, about 570 nm, about 580 nm, about 590 nm, about 600 nm, about 610 nm, about 620 nm, about 630 nm, about 640 nm, about 650 nm, about 660 nm, about 670 nm, or about 680 nm.

While the principles of the invention have been described herein, it is to be understood by those skilled in the art that this description is made only by way of example and not as a limitation as to the scope of the invention. Other embodiments are contemplated within the scope of the present invention in addition to the exemplary embodiments shown and described herein. Modifications and substitutions by one of ordinary skill in the art are considered to be within the scope of the present invention.

What is claimed:

1. A method for producing an avoidance response in an animal, comprising;
providing a plurality of illumination sources wherein the illumination source is a light emitting diode having a peak emission wavelength from about 360 nm to about 680 nm;
providing a plurality of sensors; and
providing a central controller, wherein the central controller is configured to
receive data from the plurality of sensors,
combine the data received from the plurality of sensors to create a situational awareness, and
communicate a response to the plurality of illumination sources thereby producing an avoidance response in one or more animals.

2. The method for producing an avoidance response in an animal of claim 1, wherein the situational awareness comprises the range, distance, and direction of egress of one or more animals.

3. The method for producing an avoidance response in an animal of claim 1, further comprising producing a sound within the frequency range of 200-5000 Hz.

4. The method for producing an avoidance response in an animal of claim 1, further comprising providing one or more unmanned vehicles wherein the plurality of illumination sources are connected to the one or more unmanned vehicles.

5. The method for producing an avoidance response in an animal of claim 4, wherein the one or more unmanned vehicles are stationary.

6. The method for producing an avoidance response in an animal of claim 4, wherein the one or more unmanned vehicles are operable in the air, in the water, or on land.

7. The method for producing an avoidance response in an animal of claim 4, wherein the one or more unmanned vehicles simulate top predator behavior to produce an avoidance response in one or more animals.

8. The method for producing an avoidance response in an animal of claim 7, wherein the top predator behavior comprises one of the one or more unmanned vehicles applying a maximum concurrent stimuli during an initial period followed by each of the other one or more unmanned vehicles sequentially applying a maximum stimuli.

9. The method for producing an avoidance response in an animal of claim 7, wherein the top predator behavior comprises decreasing the distance or changing the rate of change between the one or more unmanned vehicles and the one or more animals.

10. The method for producing an avoidance response in an animal of claim 1, wherein the avoidance response is an involuntary response resulting from a brightness contrast to the apparent background brightness from the perspective of the one or more animals of at least a 10:1 ratio and the illumination intensity is less than about 12 mW/cm².

11. The method for producing an avoidance response in an animal of claim 1, wherein the avoidance response is an involuntary response resulting from an induced oscillating eye pupil dilation resulting from a changing illumination state between ‘on’ and ‘off’ conditions with a time interval from about 100 milliseconds to about 5 seconds.

12. The method for producing an avoidance response in an animal of claim 1, wherein the spatial separation of the plurality of illumination sources is an angular amount from about 0 degree to about 60 degrees.

13. The method for producing an avoidance response in an animal of claim 1, wherein the response communicated by the central controller to the plurality of illumination sources is configured to modify the intensity, direction, sequence, duration of illumination, color, brightness, blinking effect, uncoordinated movement of the light, uncoordinated movement of multiple lights, or a coordinated movement of multiple lights thereby increasing the perceived risk of predation and producing an avoidance response in one or more animals.

14. The method for producing an avoidance response in an animal of claim 1, wherein the sensor is a camera.

15. The method for producing an avoidance response in an animal of claim 1, wherein the central controller determines the appropriate response to the presence of the one or more animals using rules of escalating responses to issue illumination commands consisting of range, bearing azimuth, power level of emission, duration of emission, and coordinated flashing sequence to each illumination source to be directed at the one or more animals.

16. A system for producing an avoidance response in an animal, comprising;
a plurality of illumination sources wherein the illumination source is a light emitting diode;
a plurality of sensors; and
a central controller configured to receive data from the plurality of sensors, combine the data received from the plurality of sensors to create a situational awareness, and communicate a response to the plurality of illumination sources to produce a brightness of light that is equal to or greater than the brightness perception of the animal species to the natural solar spectral irradiation found within the ecosystem of the species, thereby producing an avoidance response in an animal.

17. The system for producing an avoidance response in an animal of claim 16, wherein the plurality of illumination sources is configured to illuminate with light about 1.0 mW/cm² for spectral emissions less than about 400 nm and about 12 mW/cm² for spectral emissions from about 400 nm to about 680 nm.

18. The system for producing an avoidance response in an animal of claim 16, wherein the sensor is a camera.

19. The system for producing an avoidance response in an animal of claim 16, wherein the brightness of light is equal to or greater than a factor of 10 different from the background brightness perceived by the animal species within the ecosystem.

20. The system for producing an avoidance response in an animal of claim 16, wherein the illumination sources are configured to alternate between ‘on’ and ‘off’ conditions with a time interval from about 100 milliseconds to about 1.5 seconds.

21. The system for producing an avoidance response in an animal of claim 16, wherein the response communicated by the central controller to the plurality of illumination sources is configured to modify the intensity, direction, sequence, duration of illumination, color, brightness, blinking effect, uncoordinated movement of the light, uncoordinated movement of multiple lights, or a coordinated movement of multiple lights thereby increasing the perceived risk of predation and producing an avoidance response in one or more animals.

22. The system for producing an avoidance response in an animal of claim 16, further comprising one or more unmanned vehicles, wherein the plurality of illumination sources are connected to the one or more unmanned vehicles.

23. The system for producing an avoidance response in an animal of claim 22, wherein the one or more unmanned vehicles are stationary.

24. The system for producing an avoidance response in an animal of claim 22, wherein the one or more unmanned vehicles are operable in the air, in the water, or on land.

25. The system for producing an avoidance response in an animal of claim 22, wherein the one or more unmanned vehicles simulate top predator behavior to produce an avoidance response in one or more animals.

26. The system for producing an avoidance response in an animal of claim 25, wherein the top predator behavior comprises one of the one or more unmanned vehicles applying a maximum concurrent stimuli during an initial period followed by each of the other one or more unmanned vehicles sequentially applying a maximum stimuli.

27. The system for producing an avoidance response in an animal of claim 25, wherein the top predator behavior comprises decreasing the distance or changing the rate of change between the one or more unmanned vehicles and the one or more animals.

28. The system for producing an avoidance response in an animal of claim 16, further comprising one or more sources of sound within the frequency range of 200-5000 Hz.

29. A method of producing top predator behavior to produce an avoidance response in an animal, comprising
providing one or more unmanned vehicles;
providing a plurality of illumination sources connected to the one or more unmanned vehicles, wherein the illumination source is a light emitting diode;
providing a plurality of sensors;
providing a central controller, wherein the central controller is configured to
receive data from the plurality of sensors,
combine the data received from the plurality of sensors to create a situational awareness, and
communicate a response to the plurality of illumination sources; and
coordinating the movement of the one or more unmanned vehicles to simulate top predator behavior thereby producing an avoidance response in one or more animals.

30. The method of producing top predator behavior to produce an avoidance response in an animal of claim 29, wherein the top predator behavior comprises one of the one or more unmanned vehicles applying a maximum concurrent stimuli during an initial period followed by each of the other one or more unmanned vehicles sequentially applying a maximum stimuli.
